(19) United States
(12) Patent Application Publication
(10) Pub. No.: US 2012/0087119 A1
(43) Pub. Date: Apr. 12, 2012

(54) LED LAMP

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/086,398

(22) Filed: Apr. 14, 2011

(30) Foreign Application Priority Data
Oct. 11, 2010 (CN) 201010502724.8

(51) Int. Cl. F21V 7/00; F21V 1/00

(52) U.S. Cl. 362/235

(57) ABSTRACT

An LED lamp includes a base, a lampshade, a substrate and a light distribution board. A number of light emitting diodes are mounted on the substrate. The lampshade and the substrate are both fixed to the base. The light distribution board is positioned between the lampshade and the substrate. Opposite sides of the light distribution board respectively face the lampshade and the substrate. The light distribution board includes a number of protrusions. The base includes an oblique reflecting portion at opposite ends thereof. The reflecting portion is coated with a reflecting layer. The protrusions are configured for totally reflecting incident light with incident angle within a preset range from the light emitting diodes to the reflecting layer. The reflecting layer is configured for reflecting the reflected light to the lampshade.

### BACKGROUND

1. Technical Field

The present disclosure relates to illumination devices, especially to an LED lamp.

2. Description of Related Art

Compared to traditional light sources, light emitting diodes (LEDs) have many advantages, such as high luminous efficiency, low power consumption, and long service life. LED lights are widely used in many applications. The light emitting diodes are small and have a narrow light emitting angle. The light emitting diodes emit light that may be too bright, which can harm people's eyes.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an LED lamp according to an exemplary embodiment.

FIG. 2 is a cross-sectional view of the cut away section II-II of the LED lamp in FIG. 1.

FIG. 3 is a schematic view of light paths illustrating that the light beams emitted from light emitting diodes in a forward direction in FIG. 2 are totally reflected.

FIG. 4 is a schematic view of light paths illustrating that the light beams emitted from light emitting diodes in a forward direction in FIG. 2 are diffusely reflected.

### DETAILED DESCRIPTION

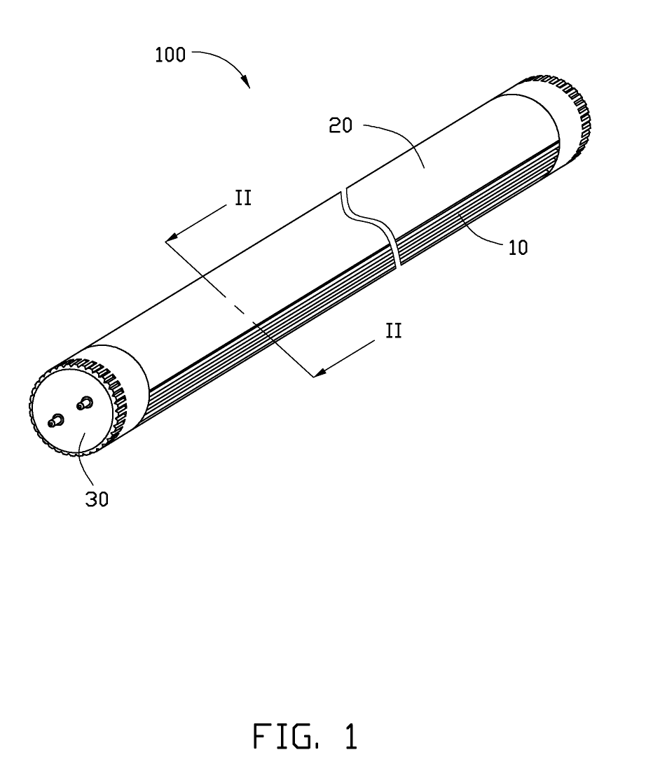

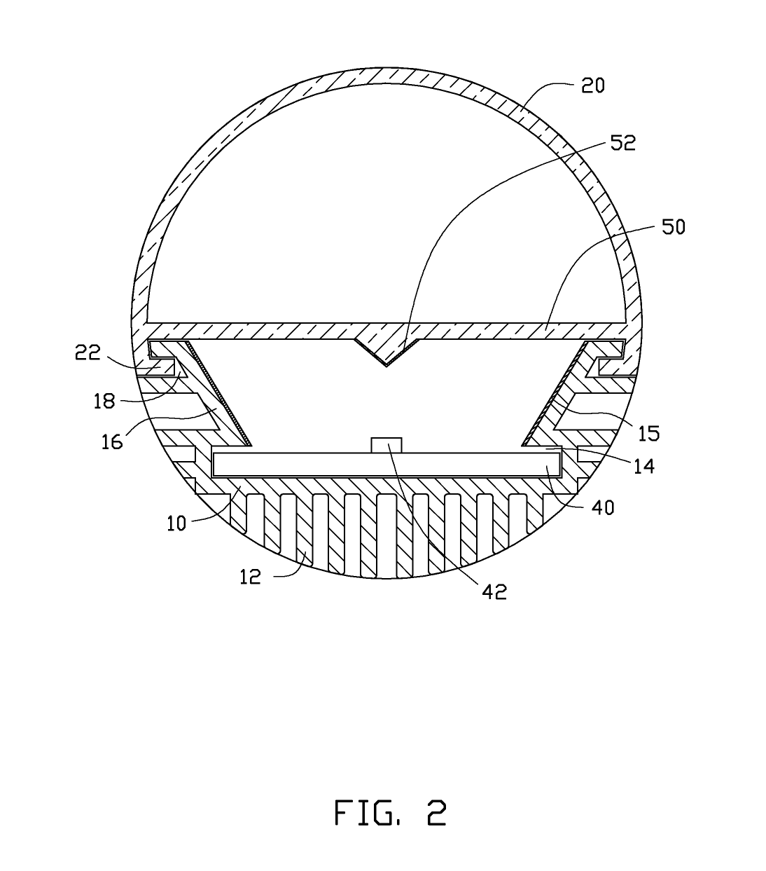

Referring to FIGS. 1 and 2, an LED lamp 100 according to an exemplary embodiment includes a base 10, a lampshade 20, a pair of power connectors 30, a substrate 40 and a light distribution board 50. The lampshade 20 and the substrate 40 are both fixed to the base 10. The light distribution board 50 is positioned between the lampshade 20 and the substrate 40. The pair of power connectors 30 are respectively fixed to opposite ends of the LED lamp 100 and used to connect with a coupling power connector (not shown), such that power can be supplied to the LED lamp 100. The substrate 40 is electrically connected to the power connectors 30. A number of light emitting diodes 42 are mounted on the substrate 40. The light distribution board 50 is configured for changing the direction of light beams from the emitting diodes 42.

The base 10 can be made of aluminum alloy with excellent thermal diffusivity and used for dispersing heat generated by the LED lamp 100. The bottom of the base 10 includes a number of fins 12 spaced apart from each other. The fins 12 are configured for increasing surface area of the base 10 to accelerate air ventilation. The base 10 defines a receiving groove 14. The substrate 40 is received in the receiving groove 14. The base includes an oblique reflecting portion 16 at opposite ends thereof. The reflecting portion 16 is coated with a reflecting layer 15. The reflecting layer 15 is configured for totally or diffusely reflecting light beams travelling thereto. Each of opposite ends of the reflecting portion 16 defines an indentation 18 in its outer side. Each of opposite ends of the lampshade 20 includes an inward protruding member 22 extending toward each other. The pair of latches 22 are respectively received in a pair of indentations 18, thereby fixing the lampshade 20 to the base 10.

The substrate 40 is affixed to the base 10 by a heat conductive adhesive. The heat conductive adhesive is used for conducting heat generated by the substrate 40 to the base 10 more effectively.

The light distribution board 50 and the lampshade 20 can be integrally formed by molding. The opposite sides of the light distribution board 50 respectively face the substrate 40 and the lampshade 20. The light distribution board 50 includes a number of protrusions 52 facing the emitting diodes 42. The cross section of the protrusion 52 can be an isosceles triangle. The protrusions 52 are configured for totally reflecting the light beams emitted from the light emitting diodes 42 in a forward direction or in an approximate forward direction to the reflecting layer. In an alternative embodiment, the cross section of the protrusion 52 may be cambered-shaped.

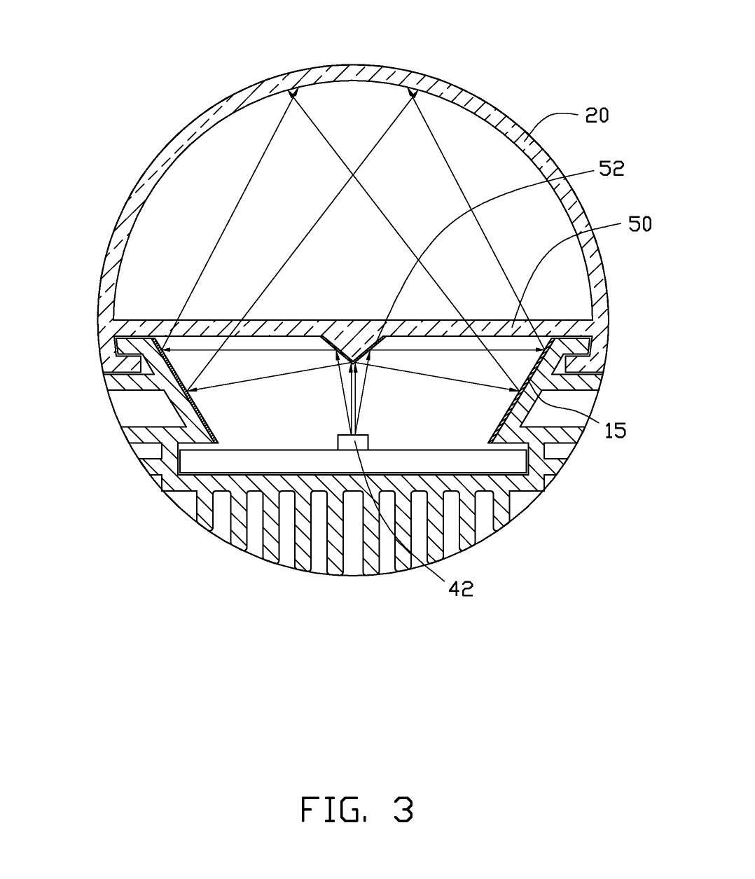

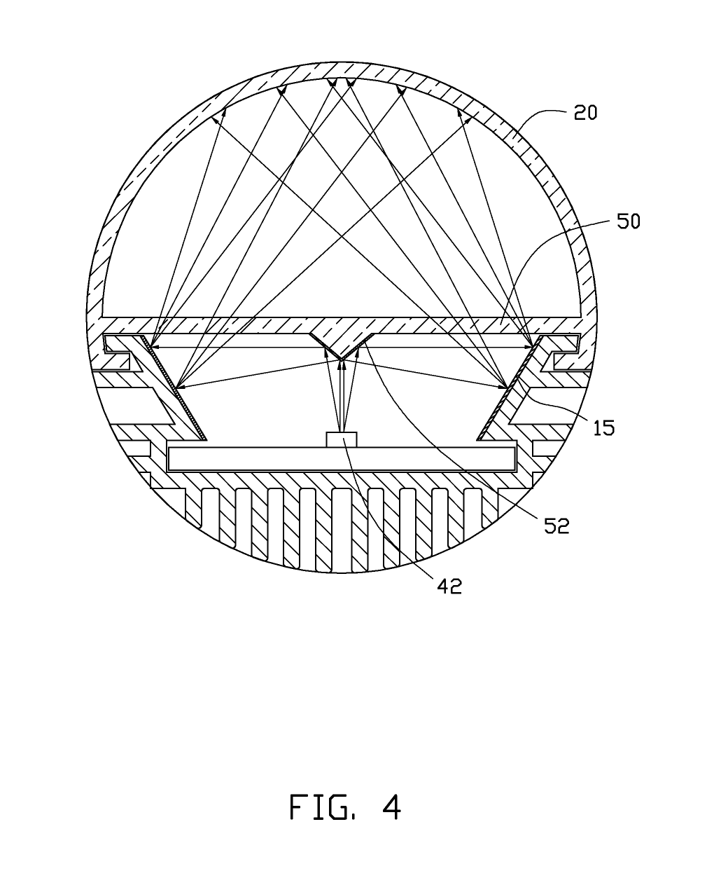

Referring to FIGS. 3 and 4, the light beams emitted from the light emitting diodes 42 in an approximate forward direction or in a forward direction enter the center protrusions 52 and are totally reflected at the reflecting layer 44 by the protrusions 52. Then the reflecting layer 44 totally or diffusely reflects the light beams to the light distribution board 50. After the light beams are reflected twice, the incident angle of the light beams travelling to the light distribution board 50 increases, correspondingly. The scope of the light beams refracted by the light distribution board to the lampshade 20 increases. In this way, the light emitting angle of the light emitting diodes 42 enlarges so the light beams become softer.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED lamp comprising:
a base;
a lampshade;
a substrate; and
a light distribution board;
wherein a plurality of light emitting diodes are mounted on the substrate, the lampshade and the substrate are both fixed to the base, the light distribution board is positioned between the lampshade and the substrate, opposite sides of the light distribution board respectively face the lampshade and the substrate, the light distribution board comprises a plurality of protrusions, the base comprises an oblique reflecting portion at opposite ends thereof, the reflecting portion surface is coated with a reflecting layer, the protrusions are configured for totally reflecting incident light with incident angle within a preset range from the light emitting diodes to the reflecting layer, the reflecting layer is configured for reflecting the reflected light to the lampshade.

2. The LED lamp of claim 1, wherein the lampshade and the light distribution board are integrally formed by molding.

3. The LED lamp of claim 1, wherein the cross section of the protrusion is isosceles triangle shaped.

4. The LED lamp of claim 1, wherein the cross section of each protrusion is cambered-shaped.

5. The LED lamp of claim 1, wherein each of the opposite ends of the base defines an indentation, each of the opposite ends of the lampshade comprises an inward protruding member extending toward each other, the pair of latches are respectively received in the pair of indentations to fix the lampshade to the base.

6. The LED lamp of claim 1, wherein the base comprises a plurality of fins spaced from each other.

7. The LED lamp of claim 1, wherein the base defines a receiving groove, the substrate is received in the receiving groove.
